(19) United States
(12) Patent Application Publication
(10) Pub. No.: US 2023/0249343 A1
(43) Pub. Date: Aug. 10, 2023

(54) MOVING OBJECT AND METHOD OF CONTROLLING MOVING OBJECT

(71) Applicant: SONY GROUP CORPORATION, TOKYO (JP)

(72) Inventor: KATSUFUMI SUGIMOTO, TOKYO (JP)

(21) Appl. No.: 18/001,324

(22) PCT Filed: Jun. 16, 2021
(86) PCT No.: PCT/JP2021/022818

§ 371 Date: Dec. 9, 2022

(30) Foreign Application Priority Data
Jun. 17, 2020 (JP) 2020-104875

(51) Int. Cl. B25J 9/16; B25J 5/00; B62D 57/032

(52) U.S. Cl. CPC B25J 9/1633; B25J 5/007; B25J 9/162; B62D 57/032

(57) ABSTRACT

In a moving object including a plurality of supporting legs with casters, stability during wheel driving is improved. The moving object includes a plurality of supporting legs respectively having bases attached to a body and casters attached to distal ends thereof. The supporting legs have a predetermined mechanical compliance characteristic by which torque is generated in a restoring direction against horizontal force exerted on the casters during wheel driving. For example, the supporting legs are modified so as to have the predetermined mechanical compliance characteristic when the moving object transitions to a driving mode in which the wheel driving is performed.

### TECHNICAL FIELD

The present technique relates to a moving object and a method of controlling the moving object, and more particularly to a moving object or the like having a plurality of supporting legs with casters attached to distal ends thereof.

### BACKGROUND ART

Moving objects that walk by operating a plurality of supporting legs so as to be able to pass over obstacles, steps, and the like are used for various purposes such as carrying luggage and providing security or entertainment. Such moving objects are also known as robots. In general, when a moving object having movable supporting legs moves by walking, the movement speed is slower than during wheel traveling. Accordingly, a moving object in which casters are attached to the distal ends of supporting legs so as to enable wheel driving in addition to walking has been proposed (for example, see PTL 1).

### CITATION LIST

### Patent Literature

[PTL 1]

JP 2009-154256 A

### SUMMARY

### Technical Problem

The above-described moving object, which is also capable of wheel driving, transitions to a driving mode in which wheel driving is performed during movement on flat ground or the like on which wheel driving is easy, and transitions to a walking mode in which walking is performed during movement on uneven ground or the like on which wheel driving is difficult. Thus, it is possible to achieve both an increase in movement speed and an improvement in uneven ground traveling ability. In the driving mode, however, the moving object may lose its posture as a result of changing the ground contact positions of the supporting legs in order to avoid an obstacle or a step on the road surface.

Even in these cases, however, the moving object can regain its posture by, for example, temporarily separating another supporting leg from the ground surface and stepping down so as to stabilize the posture. However, stepping down with a supporting leg during driving involves the risk of overturning. When the driving speed is decreased temporarily, the risk of overturning when stepping down with the supporting legs can be reduced. However, since the average speed decreases, this is not preferable. Thus, in the above-described moving object, it is difficult to improve stability when wheel driving is performed.

An object of the present technique is to improve the stability of a moving object having a plurality of supporting legs with casters during wheel driving.

A concept of the present technique involves a moving object including a plurality of supporting legs respectively having bases attached to a body and casters attached to distal ends thereof, wherein the supporting legs have a predetermined mechanical compliance characteristic by which torque is generated in a restoring direction against horizontal force exerted on the casters during wheel driving.

The present technique includes the plurality of supporting legs respectively having bases attached to the body and casters attached to the distal ends thereof. In this case, the supporting legs have a predetermined mechanical compliance characteristic by which torque is generated in a restoring direction against horizontal force exerted on the casters during wheel driving.

Since the present technique includes the plurality of supporting legs having the predetermined mechanical compliance characteristic by which torque is generated in a restoring direction against the horizontal force exerted on the casters during wheel driving, stability during wheel driving is improved.

Note that in the present technique, a control unit may be further provided in order to, for example, modify the supporting legs so as to have the predetermined mechanical compliance characteristic when the moving object transitions to a driving mode in which wheel driving is performed. In this case, the supporting legs are modified so as to have the predetermined mechanical compliance characteristic when the moving object transitions to the driving mode in which wheel driving is performed, and the posture/direction of the supporting legs is modified so that the supporting legs have the predetermined mechanical compliance characteristic during driving, for example. Thus, during driving, the posture/orientation of the supporting legs can be maintained in an optimum state for driving.

In this case, for example, the control unit may modify the supporting legs so as to have the predetermined mechanical compliance characteristic by modifying articulation angles between links of the supporting legs. Further, in this case, for example, the control unit may modify the supporting legs so as to have the predetermined mechanical compliance characteristic by modifying a joining method between the links of the supporting legs. Furthermore, in this case, for example, the control unit may modify the supporting legs so as to have the predetermined mechanical compliance characteristic by modifying a fastening strength between the links of the supporting legs.

Moreover, in the present technique, for example, the supporting legs may be configured to have the predetermined mechanical compliance characteristic with respect to a specific posture of the casters. In this case, stability is improved during driving performed with the casters in a predetermined posture.

Furthermore, in the present technique, for example, the supporting legs may be configured to have the predetermined mechanical compliance characteristic as an elastic effect corresponding to a load. In this case, stability is improved during wheel driving under a load.

### BRIEF DESCRIPTION OF DRAWINGS

FIG. 1 is an external view of a moving object serving as an embodiment.

FIG. 2 is a block diagram illustrating a configuration of the moving object serving as the embodiment.

FIG. 3 is a view illustrating an exemplary configuration of a supporting leg.

FIG. 4 is a view illustrating rotational axes of a third articulation on a caster side of the supporting leg.

FIG. 5 is a view illustrating states of an articulation angle between links during walking and driving.

FIG. 6 is a view illustrating modification of a joining method between the links of the supporting leg and a fastening strength between the links of the supporting leg.

FIG. 7 is a flowchart showing an example of procedures of leg structure modification control performed by an actuator control unit.

FIG. 8 is a view showing another exemplary configuration of a leg mechanism.

FIG. 9 is a view showing an example of postures of the supporting legs during a turn.

FIG. 10 is a view illustrating an example of a change in torsional rigidity in response to a load.

### DESCRIPTION OF EMBODIMENTS

Modes for carrying out the present invention (hereinafter referred to as “embodiments”) will be described hereinafter. The descriptions will be given in the following order.

1. Embodiment

2. Modification Example

### 1. Embodiment

[Exemplary Configuration of Moving Object]

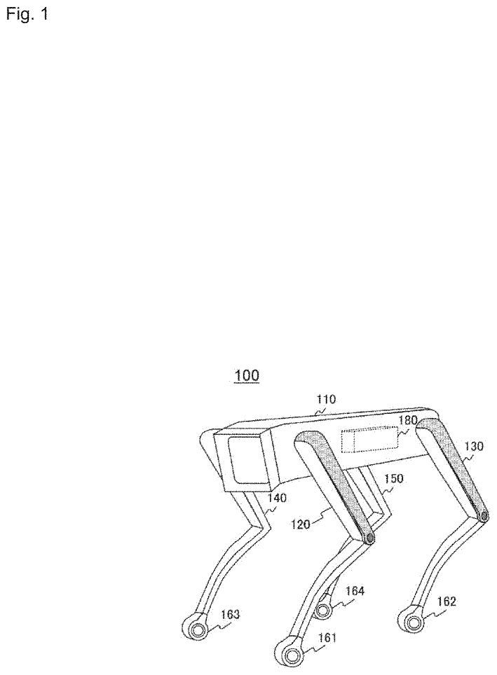

FIG. 1 is external view of a moving object 100 serving as an embodiment. The moving object 100 is an unmanned robot used for various use purposes such as carrying luggage and providing security and entertainment, and includes a body 110 and a plurality of supporting legs. Here, four of the four supporting legs 120, 130, 140, 150 include the moving object 100.

The body 110 is an elongated part, and a control unit 180 that controls the four supporting legs 120, 130, 140, 150 is provided therein.

Further, respective bases of the supporting legs 120, 130, 140, 150 are attached to the body 110, and casters 161, 162, 163, 164 are attached to respective distal ends of the supporting legs 120, 130, 140, 150. A member mounted on the distal end of an arm or a leg of a robot in this way is also known as an end effector.

Furthermore, the supporting legs 120 and 140 are attached to a front side of the body 110 and constitute front supporting legs. The supporting legs 130 and 150 are attached to a rear side of the body 110 and constitute rear supporting legs. Each of the supporting legs 120, 130, 140, 150 includes a plurality of articulations and actuators that drive the articulations.

The moving object 100 also includes various sensors (not illustrated) such as a sensor that detects an angle of the actuator, an image sensor that captures an image of a road surface, an acceleration sensor, and a gyro sensor. The acceleration sensor and the gyro sensor are provided in, for example, an inertial measurement unit (IMU).

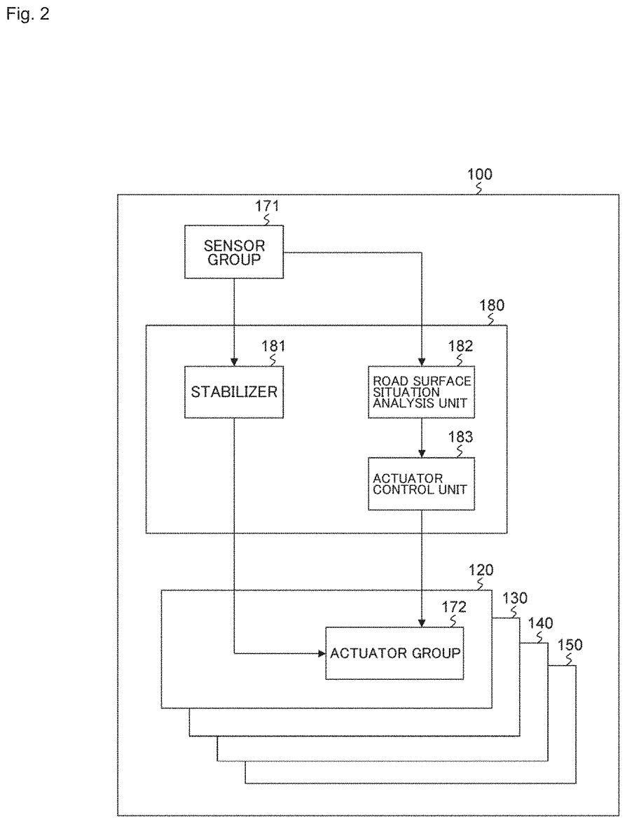

FIG. 2 is a block diagram illustrating an exemplary configuration of the moving object 100. The moving object 100 includes a sensor group 171, the control unit 180, and the four supporting legs 120, 130, 140, 150. In each of the supporting legs 120, 130, 140, 150, an actuator group 172 is provided. Further, the control unit 180 includes a stabilizer 181, a road surface situation analysis unit 182, and an actuator control unit 183.

The sensor group 171 is a sensor group that detects an internal or external situation of the moving object 100. For example, a sensor that detects an angle of the actuator, an image sensor that images a road surface, an acceleration sensor, a gyro sensor, and the like are provided as the sensor group 171. The sensor group 171 supplies detected data to the control unit 180.

The actuator group 172 is an actuator group that operates the articulations of each of the supporting legs 120, 130, 140, 150.

The stabilizer 181 performs stabilization control (for example, ZMP control) for avoiding overturning. When ZMP control is performed, the stabilizer 181 controls respective ground contact positions of leg tips (the casters 161, 162, 163, 164) of the supporting legs 120, 130, 140, 150 on the basis of a zero moment point (ZMP) and a target value of the posture of the body 110. Here, the ZMP means the operational center of gravity of a vertical floor reaction force, and posture control performed using the ZMP is known as ZMP control. The posture of the body 110 is indicated by, for example, a pitch angle of the body 110.

The stabilizer 181 acquires a present value of a present posture (the pitch angle or the like) of the body 110 from the IMU or the like. The stabilizer 181 calculates a position at which a present lifted leg is subsequently grounded and a force which arises in the perpendicular direction of the presently grounded supporting leg from a difference between the present value and a target value of a posture at which the ZMP is located within a supporting polygon.

Here, the lifted leg is a supporting leg with the leg tip removed from the road surface, and the supporting polygon is a polygon drawn by the leg tip. The stabilizer 181 inputs the calculated value into a reverse dynamic solver along with the present grounding position of the leg tip and a mechanical impedance of the leg tip. Here, the reverse dynamic solver is a program that calculates a torque which is given to an articulation when an angle, an angular velocity, and an angular acceleration of the articulation are input.

The stabilizer 181 then outputs a value of the torque calculated from the target value of the posture as a target value of the torque to the corresponding actuator in the actuator group 172.

The road surface situation analysis unit 182 analyzes a situation of a road surface using data from the image sensor or the like. The road surface situation analysis unit 182 generates a mode signal indicating one of a walking mode and a driving mode based on an analysis result and outputs the mode signal to the caster angle control unit 200.

Here, the walking mode is a mode in which the moving object 100 moves by walking and the driving mode is a mode in which the moving object 100 moves by wheel driving. For example, when the road surface is flat and there are substantially no obstacles, the driving mode is preferentially set, and when the road surface is uneven or there are obstacles on the road surface, the walking mode is preferentially set.

The supporting legs 120, 130, 140, 150 each have a predetermined mechanical compliance characteristic by which torque is generated in a restoring direction with respect to horizontal force applied to the casters 161, 162, 163, 164 during wheel driving. In this embodiment, the actuator control unit 183 switches control of the actuator group 172 to the walking mode or the driving mode on the basis of a mode signal generated by the road surface situation analysis unit 182.

When the moving object 100 transitions to the driving mode in which wheel driving is performed, the actuator control unit 183 controls the actuator group 172 so as to switch to a predetermined leg structure, whereby the supporting legs 120, 130, 140, 150 are modified so as to have the predetermined mechanical compliance characteristic.

By modifying the respective leg structures of the supporting legs 120, 130, 140, 150 so as to have the predetermined mechanical compliance characteristic when the moving object 100 transitions to the driving mode in which wheel driving is performed in this manner, leg structures having an optimum mechanical compliance characteristic for driving can be obtained during driving by the supporting legs 120, 130, 140, 150.

Note that in the above description, the moving object 100 switches the mode between the walking mode and the driving mode based on an analysis result of the road surface situation, but the present technology is not limited to this configuration. A communication interface that communicates with the outside of the moving object 100 may be further provided so that the mode can be switched in accordance with a command from the outside.

### [Exemplary Configuration of Supporting Leg]

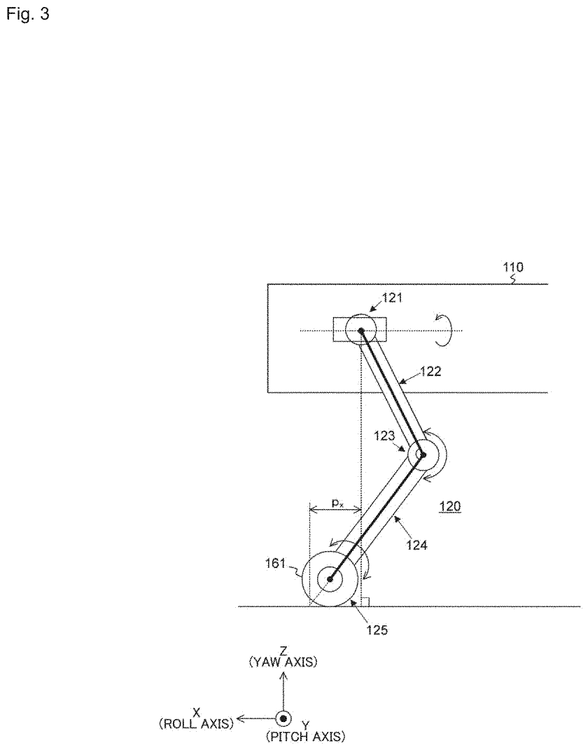

FIG. 3 illustrates an exemplary configuration of the supporting leg 120. The supporting leg 120 has a two-link structure including a first articulation 121, a link 122, a second articulation 123, a link 124, and a third articulation 125.

Hereinafter, an axis parallel to a movement direction of the moving object 100 is set as an “X axis” and a direction perpendicular to a road surface is set as a “Z axis.” An axis perpendicular to the X and Z axes is set as a “Y axis.” When an articulation is rotated around these axes, the X axis corresponds to a roll axis, the Y axis corresponds to a pitch axis, and the Z axis corresponds to a yaw axis.

The first articulation 121 is an articulation provided in the base of the supporting leg 120, which is rotated about the roll axis and the pitch axis by an actuator and corresponds to a shoulder joint when the supporting leg 120 is compared to a human arm. The second articulation 123 is rotated about the pitch axis by an actuator and corresponds to an elbow joint when the supporting leg 120 is compared to a human arm. The third articulation 125 is rotated about the pitch axis and the yaw axis by an actuator and corresponds to a wrist joint when the supporting leg 120 is compared to a human arm.

The link 122 is a member that connects the first articulation 121 to the second articulation 123. The link 124 is a member that connects the second articulation 123 to the third articulation 125.

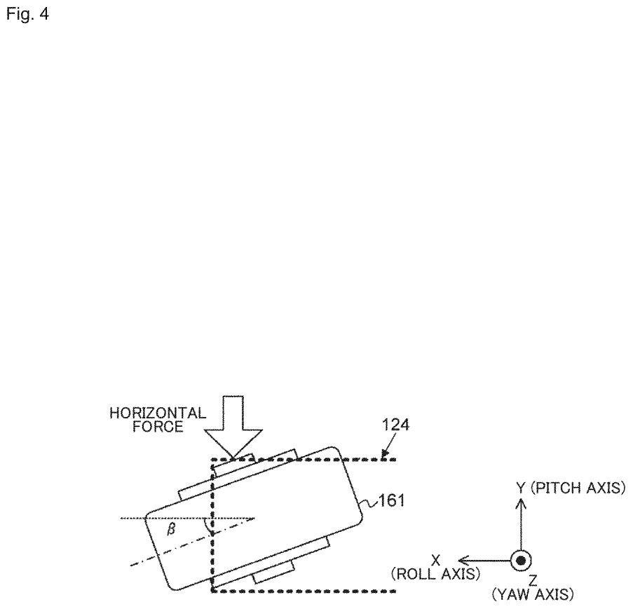

FIG. 4 is a view illustrating rotational axes of the third articulation 125. This figure is a top view showing the caster 161 from the yaw axis, among the rotational axes of the third articulation 125.

When the moving object 100 is assumed to be driving straight ahead and a disturbance acts on the caster 161 or the like during driving, force acts on the caster 161 or the like in a direction perpendicular to the side surface thereof, or in other words a horizontal direction. This force is referred to hereinafter as “horizontal force”. Here, a condition is conceivable in which a direction or a posture of the caster 161 is restored without divergence or vibration and a specific direction or posture converges when the horizontal force arises during straight ahead driving.

A moment about the yaw axis (the Z axis) acting on the caster 161 will be considered. When torsional rigidity in the articulation from the body 110 to the caster 161 is set as Kₜ and the yaw angle of the caster 161 is changed by β_{F} due to a change in the posture caused by a horizontal force F_{S}, the following expression (1) is established.

KₜβF_{Spx} (1)

Here, pₓ is a distance on the roll axis (the X axis) between a point at which a straight line along the link 124 intersects the road surface and the base, and the unit thereof is meters (m), for example. pₓ is generally known as the caster trail. Further, the unit of the torsional rigidity Kₜ is newtons per meter (N/m), for example. The unit of the angle β_{F} is radians (rad), for example.

Here, when an angle of sideslip occurring in the caster 161 is set as β, the following expression (2) is established, assuming that change toward the front side of the paper surface in FIG. 3 is positive.

β=−β_{F}=−F_{Spx}/Kₜ (2)

Now, the horizontal force F_{S} has a positive component in the direction of the back side of the paper surface in FIG. 3, while change in β toward the front side of the paper surface in FIG. 3 is positive. Due to the properties of the caster 161, when the sign of β switches to negative, stability is achieved, and therefore, by ensuring that the torsional rigidity Kₜ satisfies the following expression (3), stability is achieved. In this case, the supporting leg 120 is assumed to have a predetermined mechanical compliance characteristic (the torsional rigidity Kₜ) by which torque is generated in a restoring direction with respect to the horizontal force Fs exerted on the caster 161.

⁻pₓ/Kₜ≥0 (3)

Note that although detailed description thereof has been omitted, the respective configurations of the supporting legs 130, 140, and 150 are identical to that of the supporting leg 120.

### [Modification of Leg Structure]

As described above, when the moving object 100 transitions to the driving mode in which wheel driving is performed, the actuator control unit 183 modifies the leg structure by controlling the actuator group 172, whereby the supporting legs 120, 130, 140, 150 are modified so as to have the predetermined mechanical compliance characteristic described above.

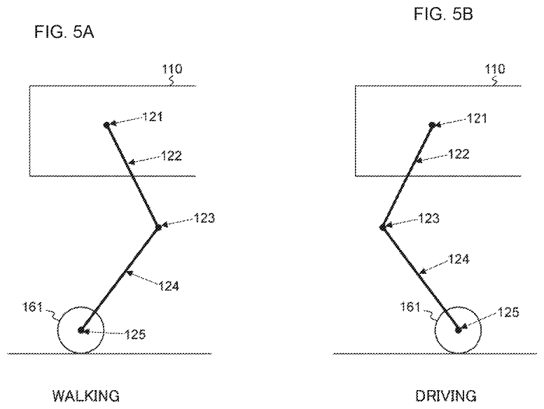

As an example of modification of the leg structure for realizing the predetermined mechanical compliance characteristic described above, the articulation angles between the links of the supporting legs, and accordingly the posture/orientation of the supporting legs, may be modified. FIG. 5(a) shows a state before the articulation angles between the links are modified, or in other words a state during walking, and FIG. 5(b) shows a state after the articulation angles between the links are modified, or in other words a state during driving. In this case, as regards a target posture/orientation to transition to during driving, a posture/orientation at which the predetermined mechanical compliance characteristic is realized is set in advance, and the posture/orientation is changed to the preset posture/orientation.

Note that when the articulation angles between the links of the supporting legs (the posture/orientation of the supporting legs) are modified from the state during walking to the state during driving, the supporting legs may be subjected to the modification control successively rather than modifying all of the supporting legs simultaneously. For example, when transitioning from the walking mode to the driving mode, the articulation angles between the links may be modified in order from the supporting leg that contacts the ground so as to become capable of wheel driving.

As further examples of modification of the leg structure for realizing the predetermined mechanical compliance characteristic described above, the joining method between the links of the supporting legs may be modified, the fastening strength between the links of the supporting legs may be modified, and so on.

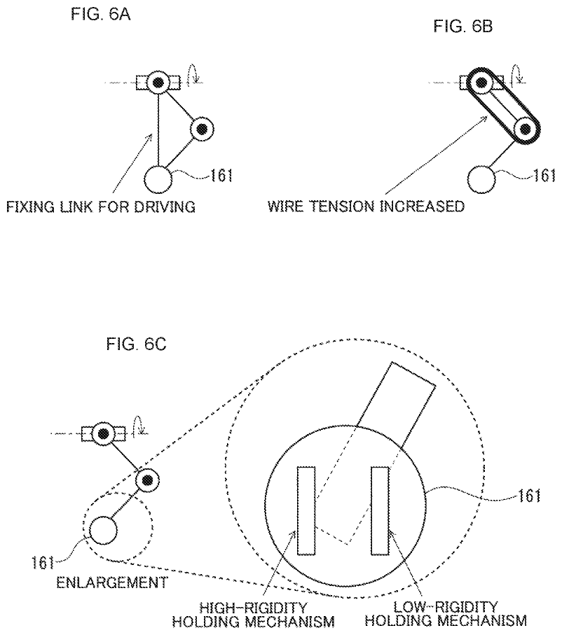

For example, FIG. 6(a) shows an example in which the mechanical compliance characteristic is changed by increasing the number of links fastening the body 110 to the caster 161 during wheel driving. Further, for example, FIG. 6(b) shows an example in which the mechanical compliance characteristic from the body 110 to the caster 161 is changed by modifying the wire tension between the links during wheel driving so as to modify the rigidity between the links.

Furthermore, for example, FIG. 6(c) shows an example in which a desired mechanical compliance characteristic is realized by dividing the structure for holding the caster 161 part so as to introduce anisotropy in the front/rear rigidity. Likewise in this case, by modifying either the front or the rear fastening strength, the mechanical compliance characteristic can be changed.

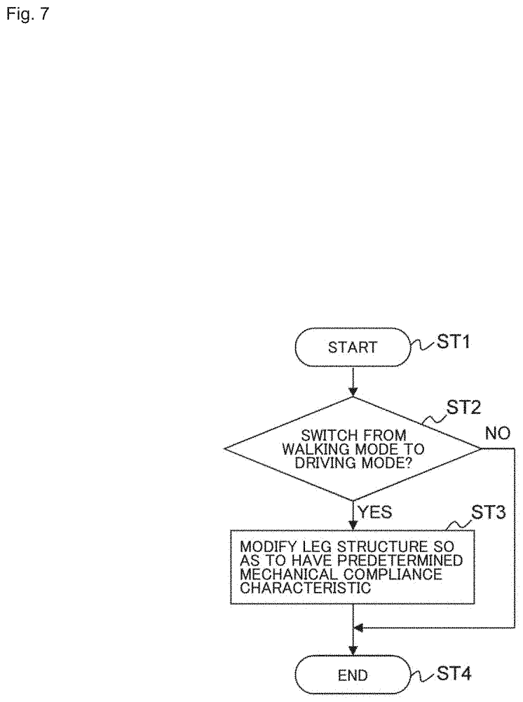

The flowchart of FIG. 7 shows an example of procedures of leg structure modification control performed by the actuator control unit 183. The actuator control unit 183 executes the processing of this flowchart periodically.

The actuator control unit 183 starts the processing in step ST1 and then determines in step ST2 whether or not to switch from the walking mode to the driving mode. In this case, the actuator control unit 183 makes the determination on the basis of the mode signal from the road surface situation analysis unit 182, for example.

Having determined to switch to the driving mode, the actuator control unit 183 controls the actuator group 172 in step ST3 so as to switch to a leg structure having the predetermined mechanical compliance characteristic. Following the processing of step ST3, the actuator control unit 183 terminates the processing in step ST4. Further, having determined not to switch to the driving mode in step ST2, the actuator control unit 183 terminates the processing immediately in step ST4.

As described above, the moving object 100 shown in FIG. 1 includes the supporting legs 120 to 150, which have a predetermined mechanical compliance characteristic by which torque is generated in a restoring direction against horizontal force exerted on the casters 161 during wheel driving, and as a result, stability during wheel driving can be improved. In this case, even when the leg tips of the supporting legs 120 to 150 are shifted by horizontal force generated as a result of a disturbance during wheel driving, the leg tips are automatically restored, thereby eliminating the need to pay special attention to step changing and so on.

Furthermore, in the moving object 100 shown in FIG. 1, the supporting legs 120 to 150 are modified so as to have the predetermined mechanical compliance characteristic when transitioning to the driving mode in which wheel driving is performed, and for example, the posture/orientation of the supporting legs 120 to 150 is modified so that the predetermined mechanical compliance characteristic is realized during driving. Hence, during driving, the posture/orientation of the supporting legs can be maintained in an optimum state for driving.

Further, in the moving object 100 shown in FIG. 1, the posture/orientation of the supporting legs is modified by modifying the leg structure, for example the articulation angles between the links of the supporting legs 120 to 150, is modified so that the supporting legs 120 to 150 have the predetermined mechanical compliance characteristic when transitioning to the driving mode in which wheel driving is performed, and as a result, the predetermined mechanical compliance characteristic can be realized without adding actuators or additionally providing special mechanisms or sensors.

Furthermore, in the moving object 100 shown in FIG. 1, there is no need to strengthen leg tip impedance control in order to maintain the positions of the leg tips (the casters 161) relative to the body 110. Hence, disturbances are less likely to reach the body 110, and therefore the effect of a disturbance generated by the road surface on the movement of the robot itself can be reduced, and the loads exerted on the links/articulations linking the body 110 to the leg ends can also be reduced. As a result, strength/rigidity can be reduced, enabling a reduction in the weight of the link portions.

### 2. Modification Example

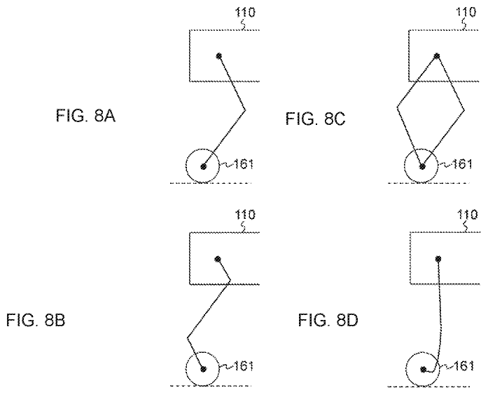

Note that in the embodiment described above, an example in which the leg mechanism has a two-link configuration such as that shown in FIG. 8(a) was described, but the leg mechanism to which the present technique can be applied is not limited thereto. For example, the leg mechanism may be a three-link configuration such as that shown in FIG. 8(b), a closed link configuration such as that shown in FIG. 8(c), a curved link configuration such as that shown in FIG. 8(d), and so on. Although not shown in the figures, a Stewart platform type link mechanism, for example, may also be employed.

Further, in the embodiment described above, the posture of the casters 161 is premised on driving straight ahead, but the mechanical compliance characteristic may be set so that stability is achieved in a specific posture of the casters 161. Furthermore, in the embodiment described above, driving straight ahead is likewise envisaged in relation to the posture of the supporting legs 120-150 to which the casters 161 are fixed, but designs may be implemented with any posture in mind.

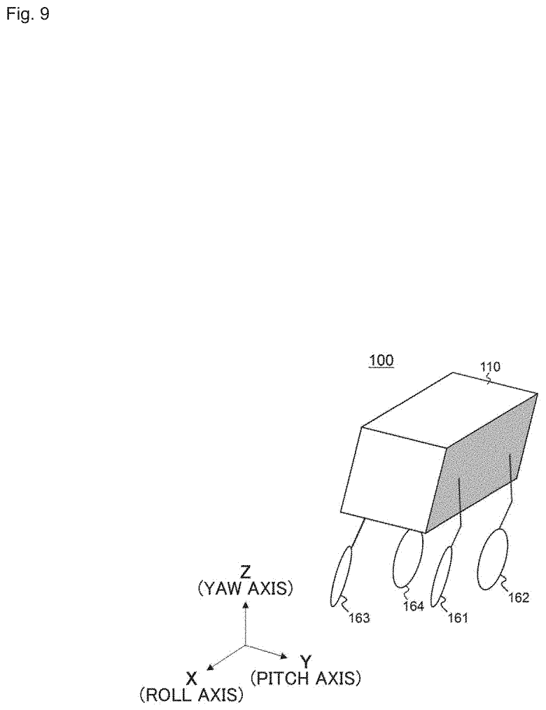

For example, turning by the moving object 100 may be considered. A case in which the supporting legs 120 to 150 take a posture such as that shown in FIG. 9, for example, during a turn may be envisaged.

When Kₜ is set as the torsional rigidity of the articulations from the body 110 to the caster 161 and β is set as the angle of sideslip occurring in the caster 161 when the yaw angle of the caster 161 changes by β_{F} due to a change in the posture in response to the horizontal force F_{S}, the following expression (4) is established. Expression (4) is the same as expression (2) described above (see FIGS. 3 and 4).

β=−β_{F}=−F_{Spx}/Kₜ (4)

Here, in order to achieve stability about a target value βref during a turn, a difference from the target value βref is set as Δβ, whereby the following expression (5) is established.

Δβ=βref−β=βref+F_{Spx}/Lₜ (5)

Due to the properties of the casters 161, stability is achieved when the sign of Δβ turns negative relative to the horizontal force F_{S}, and therefore stability is achieved when the torsional rigidity Kₜ satisfies the following expression (6). In this case, the supporting leg 120 has a predetermined mechanical compliance characteristic (the torsional rigidity Kₜ) by which torque is generated in a restoring direction relative to the horizontal force F_{S} exerted on the caster 161 during the turn.

−βref/Fₛ_{^{−hd px}}/Kₜ≥0 (6)

Furthermore, in the embodiment described above, an example in which the mechanical compliance characteristic (the torsional rigidity Kₜ) is modified so as to satisfy expression (3) by modifying the leg structure (the articulation angles between the links of the supporting legs or the like) was described. However, a mechanical compliance characteristic (a torsional rigidity Kₜ) that satisfies expression (3) may also be obtained as an elastic effect corresponding to a load such as a carrying load or an aerodynamic load, and design and control may be implemented using this effect as a premise.

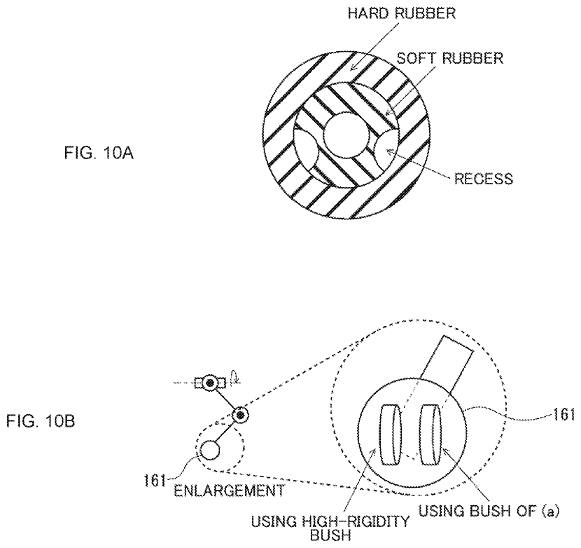

An example in which the torsional rigidity Kₜ varies in accordance with the load will be described. Here, for example, a bush (a slide bearing) having a cross-sectional structure such as that shown in FIG. 10(a), for example, will be considered. The rigidity of the bush in a left-right direction decreases when a load is exerted thereon. As shown in FIG. 10(b), by using a bush having the structure shown in FIG. 10(a) on the rear of the holding part of the caster 161, the sign of the torsional rigidity Kₜ changes when a load is applied, whereby expression (3) can be satisfied, and as a result, the stability during wheel driving can be improved.

Although preferred embodiments of the present disclosure have been described in detail with reference to the accompanying drawings as described above, the technical scope of the present disclosure is not limited to such examples. It is apparent that those having ordinary knowledge in the technical field of the present disclosure could conceive various modified examples or changed examples within the scope of the technical ideas set forth in the claims, and it should be understood that these also naturally fall within the technical scope of the present disclosure.

Further, the effects described in the present specification are merely explanatory or exemplary and are not intended as limiting. That is, the techniques according to the present disclosure may exhibit other effects apparent to those skilled in the art from the description herein, in addition to or in place of the above effects.

In addition, the present technique can also adopt the following configurations.

(1) A moving object including a plurality of supporting legs respectively having bases attached to a body and casters attached to distal ends thereof, wherein the supporting legs have a predetermined mechanical compliance characteristic by which torque is generated in a restoring direction against horizontal force exerted on the casters during wheel driving.
(2) The moving object according to (1), further including a control unit that modifies the supporting legs so as to have the predetermined mechanical compliance characteristic when the moving object transitions to a driving mode in which the wheel driving is performed.
(3) The moving object according to (2), in which the control unit modifies the supporting legs so as to have the predetermined mechanical compliance characteristic by modifying articulation angles between links of the supporting legs.
(4) The moving object according to (2), in which the control unit modifies the supporting legs so as to have the predetermined mechanical compliance characteristic by modifying a joining method between links of the supporting legs.
(5) The moving object according to (2), in which the control unit modifies the supporting legs so as to have the predetermined mechanical compliance characteristic by modifying a fastening strength between links of the supporting legs.
(6) The moving object according to any of (1) to (5), in which the supporting legs have the predetermined mechanical compliance characteristic with respect to a specific posture of the casters.
(7) The moving object according to (1), in which the supporting legs have the predetermined mechanical compliance characteristic as an elastic effect corresponding to a load.
(8) A control method for a moving object including a plurality of supporting legs respectively having bases attached to a body and casters attached to distal ends thereof,
the control method including modifying the supporting legs so as to have a predetermined mechanical compliance characteristic when the moving object transitions to a driving mode in which wheel driving is performed.

### REFERENCE SIGNS LIST

100 Moving object
110 Body
120, 130, 140, 150 Supporting leg
121 First articulation
122, 124 Link
123 Second articulation
125 Third articulation
161, 162, 163, 164 Caster
171 Sensor group
172 Actuator group
180 Control unit
181 Stabilizer
182 Road surface situation analysis unit
183 Actuator control unit

1. A moving object comprising a plurality of supporting legs respectively having bases attached to a body and casters attached to distal ends thereof,
wherein the supporting legs have a predetermined mechanical compliance characteristic by which torque is generated in a restoring direction against horizontal force exerted on the casters during wheel driving.

2. The moving object according to claim 1, further comprising a control unit that modifies the supporting legs so as to have the predetermined mechanical compliance characteristic when the moving object transitions to a driving mode in which the wheel driving is performed.

3. The moving object according to claim 2, wherein the control unit modifies the supporting legs so as to have the predetermined mechanical compliance characteristic by modifying articulation angles between links of the supporting legs.

4. The moving object according to claim 2, wherein the control unit modifies the supporting legs so as to have the predetermined mechanical compliance characteristic by modifying a joining method between links of the supporting legs.

5. The moving object according to claim 2, wherein the control unit modifies the supporting legs so as to have the predetermined mechanical compliance characteristic by modifying a fastening strength between links of the supporting legs.

6. The moving object according to claim 1, wherein the supporting legs have the predetermined mechanical compliance characteristic with respect to a specific posture of the casters.

7. The moving object according to claim 1, wherein the supporting legs have the predetermined mechanical compliance characteristic as an elastic effect corresponding to a load.

8. A control method for a moving object comprising a plurality of supporting legs respectively having bases attached to a body and casters attached to distal ends thereof,
the control method comprising modifying the supporting legs so as to have a predetermined mechanical compliance characteristic when the moving object transitions to a driving mode in which wheel driving is performed.
